(19) United States
(12) Patent Application Publication
(10) Pub. No.: US 2011/0241812 A1
(43) Pub. Date: Oct. 6, 2011

(54) MAGNETIC FIELD GENERATOR BASED ON DUAL PERMANENT MAGNET RINGS

(76) Inventors: Grum Teklemariam, Washington, DC (US); Jianyu Lian, Westford, MA (US)

(21) Appl. No.: 13/133,422

(22) PCT Filed: Dec. 11, 2009
(86) PCT No.: PCT/US09/67735

§ 371 Date: Jun. 8, 2011

(30) Foreign Application Priority Data
Dec. 12, 2008 (US) 61/121915

(51) Int. Cl. H01F 7/02

(52) U.S. Cl. 335/302

(57) ABSTRACT

A magnet assembly primarily for use in MRI applications is disclosed comprising two main permanent magnet rings that are spaced-apart and arranged to be coaxially aligned with two easy-access openings. The magnetization direction in each magnet ring is substantially radially oriented and maintains an anti-parallel orientation with respect to each other. Together, these two magnet rings create a homogeneous and strong magnetic field in the central enclosure between them with two orthogonal access paths to the enclosure. Through one access pathway a patient can be inserted while through the other pathway a doctor can fully access the patient and perform interventional procedures during a real-time MRI scan. Embodiments of the system also have poles and yokes that shape the field and minimize fringe fields. Embodiments of this magnet assembly can achieve high magnetic fields for whole-body scanning without saturating the magnet pole and other structures.

### CROSS-REFERENCE TO RELATED APPLICATIONS:

This application claims the benefit of U.S. Provisional Patent App. No. 61/121,915, filed on Dec. 12, 2008, entitled “MAGNETIC FIELD GENERATOR BASED ON DUAL PERMANENT MAGNET RINGS,” the entire contents of which is incorporated herein by reference.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

1. Field of the Invention:

The invention relates to permanent magnet designs that can generate very strong and highly homogeneous fields primarily for NMR, MRI and MRT use.

2. Description of the Related Art:

It is often desirable in Magnetic Resonance Imaging (MRI) applications to have strong and homogeneous magnetic fields. To date, generally two types of magnet systems have been used: open and closed. Open systems create a vertical dipolar magnetic field by use of a lower and upper field source means with the space in between used for imaging purposes. In the closed systems, usually a cylindrical type configuration is used with field sources around the cylinder and the inside used for imaging purposes.

For applications that require access to the patient, for example in interventional procedures, an open magnet configuration has been employed where two spaced-apart superconducting coil assemblies have been arranged into Helmholtz type geometry. The space between the coils allows access for medical practitioners while patients can be positioned inside the bore. Moreover, the open space alleviates feelings of claustrophobia. With this and other configurations, to achieve magnetic fields of 0.5 T or greater, the magnetic field sources were usually superconductive wires and required cryogenics.

### BRIEF SUMMARY OF THE INVENTION

The following summary is included only to introduce some concepts discussed in the Detailed Description below. This summary is not comprehensive and is not intended to delineate the scope of protectable subject matter, which is set forth by the claims presented.

It is an object of embodiments of the present invention to provide a magnet system that is suitable for MRI purposes with easy and complete access to a patient by doctors and surgeons during real-time MRI scanning. In this invention, a dual permanent magnet ring system is used to both generate a strong and homogeneous magnetic field in the central enclosure between the two rings while at the same time providing easy access to the patient in between the dual ring arrangement. This system is maintenance free in that once the permanent magnets are energized they stay magnetized for the lifetime of the system that typically lasts more than 10 years.

One objective of embodiments of this invention is that the magnet system be composed of two main coaxial permanent magnet rings.

In accordance with this invention, the magnetization orientations are radially directed and are arranged so that the one ring is anti-parallel in orientation with respect to the other.

Consequently, such an arrangement of permanent magnet arrays has the effect of generating a strong and homogeneous field in the central enclosure between the two rings.

A further feature of embodiments of this invention relates to varying the magnetization orientations or tilting them away from the radial direction to control homogeneity and field strength.

Another feature of this invention for controlling homogeneity is obtained by splitting each ring into two or more sections and varying the spacing as required.

A major invention of the current system relates to the easy access provided in between the rings.

In one preferred embodiment of this invention, a ferromagnetic pole is used to enclose the bore of the rings with shim rings on one edge to homogenize the magnetic field in the central enclosure and limit the amount of field leakage.

It is another object of embodiments of the invention to provide a magnet system for use in magnetic resonance imaging applications, where the magnet system comprises a first and second permanent magnet ring arranged coaxially and placed at a distance from each other, each magnet ring having a bore and a magnetization substantially radially oriented, the magnetization in the first ring maintaining an orientation that is substantially opposed to magnetization in the second ring, the magnetizations generate a dipolar magnetic field axially oriented in an isocenter of the first and second permanent magnet rings and the magnetic rings having a yoke like ferromagnetic structure covering.

It is yet another object of embodiments of the invention to provide a magnet system wherein the magnetic rings have a yoke like ferromagnetic structure covering and the system further comprises a ferromagnetic pole tip.

Other aspects of the invention will become clear from the drawings and detailed description to follow.

### BRIEF DESCRIPTION OF THE SEVERAL VIEWS OF THE DRAWINGS

In order that the manner in which the above-recited and other advantages and features of the invention are obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 is a pictorial depiction of one embodiment of the invention with a quarter section cutaway showing the primary magnetization orientations. The primary magnetic field direction will be oriented along the axial direction or the z-axis in the figure.

FIG. 2 is a 2 dimensional axisymmetric, finite-difference half model of one embodiment of the magnet in this invention showing the fluxes including poles and yokes used to homogenize the field in the center and contain leakage flux. The z-axis is the axisymmetric axis.

FIG. 3 is a 3 dimensional axisymmetric, quarter model of one embodiment of the magnet in this invention showing the vector field in the central plane.

FIG. 4 is a 3 dimensional axisymmetric, octant model of one embodiment of the magnet in this invention showing split ring magnets at different spacing to control homogeneity.

### DETAILED DESCRIPTION OF THE INVENTION

A magnetic field generator system will now be described in detail with reference to the accompanying drawings. Notwithstanding the specific example embodiments set forth below, all such variations and modifications that would be envisioned by one of ordinary skill in the art are intended to fall within the scope of this disclosure.

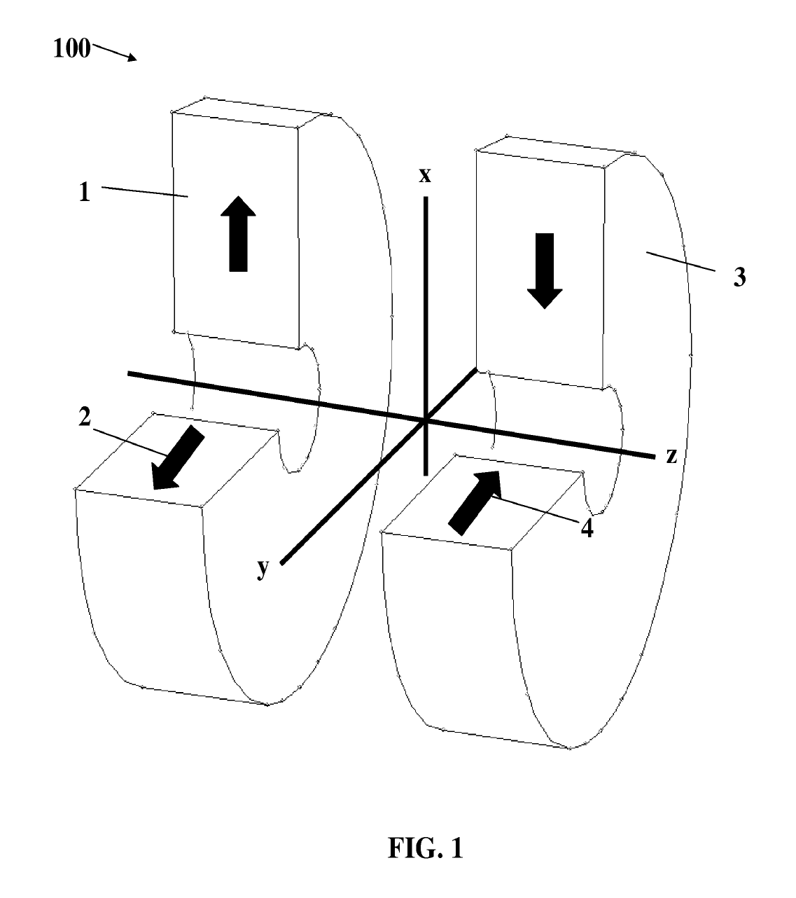

System 100 of FIG. 1 shows a preferred embodiment of the open MRI magnet in this invention. The figure depicts a pictorial of the preferred magnet with one quarter cut out. It consists of dual ring permanent magnets, 1 and 3 with the magnetization orientations, 2 and 4 as depicted in FIG. 1. The orientations are radial and maintain an anti-parallel orientation between the two rings. That is, if the orientation 2 is radially out in ring 1 as depicted in FIG. 1, then orientation 4 has to be radially in or anti-parallel in ring 3 again as depicted in FIG. 1. These orientations between the rings have to generally hold this relationship amongst them. So if orientation 2 changes to radially in then orientation 4 has to be radially out.

In the system 100 the patient is generally positioned along the axis z. Medical practitioners can access the patient between the rings 1 and 3. Alternatively, the patient can be inserted along the axes x or y. In either configuration, the magnet enclosure offers a very open space for the patient.

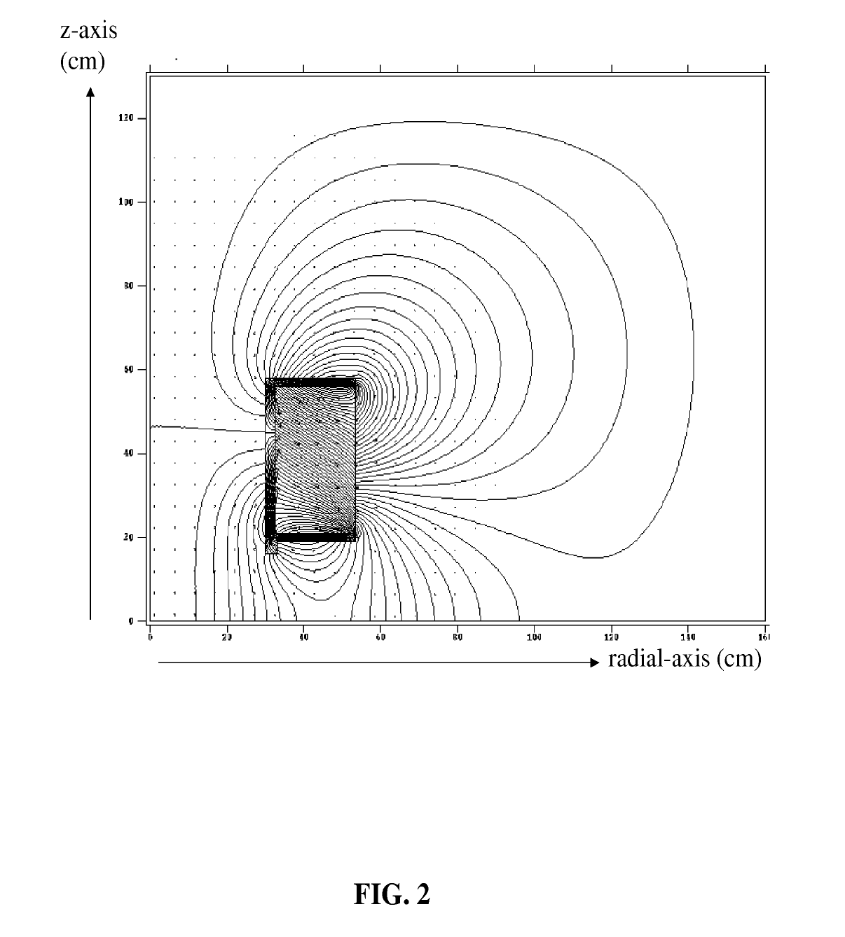

The model in FIG. 2 is a 2 dimensional (2D) axisymmetric, finite-difference quarter model of the system 100 of FIG. 1. The coordinate (0,0) in FIG. 2 is the isocenter of the magnet and the analysis shows that a homogeneous magnetic field region exists for MRI imaging. As shown in FIG. 2 the magnetization is substantially radially out however the orientation is still tilted away from directly radially out to obtain the best homogeneity. This is part of the design that allows shimming the magnet in the design stage.

Furthermore, FIG. 2 also shows the use of ferromagnetic enclosures used to average out the inherent nonuniformities in the properties of permanent magnet materials which can be as much as a few percent. This is critical since most MRI magnets need to achieve 1 ppm or better homogeneity in the active imaging region. Moreover, these ferromagnets also serve to contain the field leakage. Additionally, a pole tip is used to shim the homogeneity of the magnetic field in the isocenter as shown in FIG. 2.

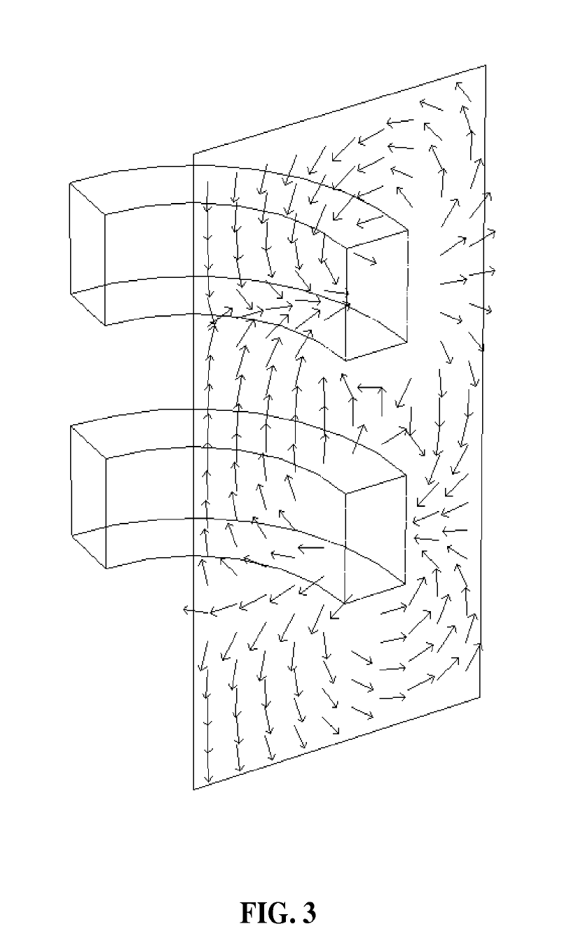

FIG. 3 is a 3D axisymmetric, quarter model of system 100 of FIG. 1. It demonstrates that system 100 operates as envisioned in this invention as evidenced by the vector field plot in the central plane. The field lines are axially oriented and the magnetization orientation in the upper ring is radially out while in the lower ring it is radially in as can be seen from the vector field plots in FIG. 3.

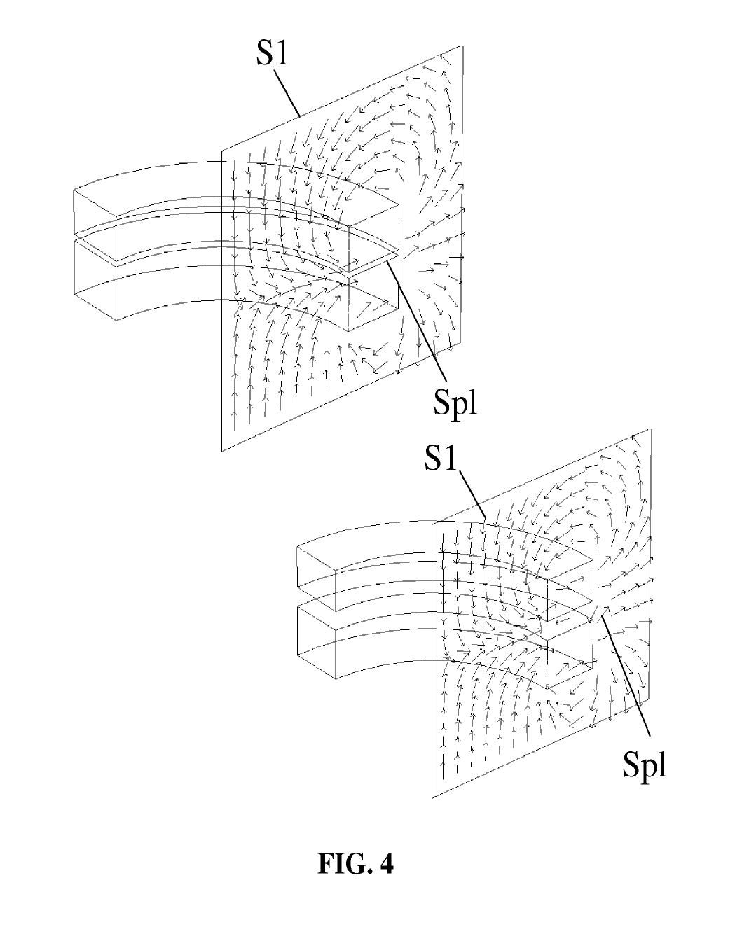

Finally, FIG. 4 shows 3D axisymmetric, octant models of system 100 to demonstrate the effect of splitting each individual ring. As can be seen in the vector field plots, as the spacing is varied between the split rings the flux flows are altered consequently affecting the imaging region field distribution and thereby using this degree of freedom to further shim the magnetic field.

A problem that arises at high field strengths is the increase in the internal demagnetizing field of the permanent magnets. To avoid this problem, analysis has shown that orienting the magnetization direction in the outer portions of the split rings substantially away from radial towards the axial direction offers a good compromise between reducing the internal demagnetizing field and the achievable central field strengths.

The drawings and descriptions while demonstrating the main objects of the invention, together with the claims below are in no way meant to limit the scope and spirit of the invention. Changes in form and details of the invention will be understood not to depart from the current invention.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

What is claimed is:

1. A magnet for use in MRI applications, said magnet generally comprising:
dual permanent magnet rings arranged coaxially and spaced-apart so that patients can be positioned in either the bore or the space in between the rings for the purposes of imaging and accessing the patient during a scan;
said permanent rings having magnetization substantially radially oriented;
further, said magnetization in one ring maintaining an orientation that is substantially opposed or antiparallel with respect to the other ring;
and generating a dipolar magnetic field axially oriented in the isocenter of the said dual permanent magnet rings;
further, covering the said rings with yoke like ferromagnetic structures;
and further, using a ferromagnetic pole tip like structure.

2. The said permanent magnet rings of claim 1 wherein each is made of permanent magnet alloys of the Nd—Fe—B type.

3. The said permanent magnet rings of claim 1 wherein said rings are spaced-apart and are coaxial with an inner enclosure for inserting subjects for the purposes of MRI examinations and interventional procedures by surgeons.

4. The said magnetization orientations of the dual permanent magnet rings of claim 1 wherein the orientations can be tilted away from radial so that optimal field homogeneity can be achieved in the isocenter.

5. The said permanent magnet rings of claim 1 wherein each one can be split and spaced apart so that further control over the homogeneity and field strength of the field can be achieved in the isocenter.

6. The said split permanent magnet rings of claim 5 wherein the magnetization directions of the outer portions of the split rings can be substantially oriented towards the axial direction to minimize the internal demagnetizing field in the permanent magnets.

7. The yoke-like ferromagnetic structures of claim 1 wherein they are used to contain leakage field.

8. Further, the yoke-like structure of claim 1 is used to average out the inherent nonuniformities of the permanent magnet material properties.

9. The use of pole tips in claim 1 to further achieve better homogeneity in the isocenter.

10. The magnetic field generating apparatus so formed as stated in claim 1 having two orthogonal access pathways to the said inner enclosure.

11. A magnet system for use in magnetic resonance imaging applications, said magnet comprising:
a first and second permanent magnet ring arranged coaxially and placed at a distance from each other;
each magnet ring having a bore and a magnetization substantially radially oriented;
the magnetization in the first ring maintaining an orientation that is substantially opposed to magnetization in the second ring;
the magnetizations generate a dipolar magnetic field axially oriented in an isocenter of the first and second permanent magnet rings; and
the magnetic rings having a yoke like ferromagnetic structure covering.

12. The magnet system of claim 11 wherein the magnetic rings have a yoke like ferromagnetic structure covering.

13. The magnet system of claim 11 wherein the system further comprises a ferromagnetic pole tip.

14. The magnet system of claim 11 wherein the distance between the first and second magnet ring allows a patient to be positioned between the magnet rings for imaging.

15. The magnet system of claim 11 wherein the size of the bore allows a patient to be positioned within the bore for imaging.
